(19) United States
(12) Patent Application Publication
(10) Pub. No.: US 2016/0021271 A1
(43) Pub. Date: Jan. 21, 2016

(54) IMAGE FORMING APPARATUS WHICH GENERATES IMAGES OF WEB PAGES

(71) Applicant: Konica Minolta, Inc., Tokyo (JP)

(72) Inventors: Toshihiko OTAKE, Ikeda-shi (JP); Atsushi OHSHIMA, Amagasaki-shi (JP); Takehisa YAMAGUCHI, Ikoma-shi (JP); Hiroaki KUBO, Muko-shi (JP); Toshimichi IWAI, Nara-ken (JP); Tomoaki NAKAJIMA, Kobe-shi (JP); Masaya HASHIMOTO, Itami-shi (JP)

(73) Assignee: Konica Minolta, Inc., Tokyo (JP)

(21) Appl. No.: 14/801,246

(22) Filed: Jul. 16, 2015

(30) Foreign Application Priority Data
Jul. 18, 2014 (JP) 2014-147920

(51) Int. Cl. H04N 1/00; H04N 1/333

(52) U.S. Cl. CPC H04N 1/00875; H04N 1/00244; H04N 1/33346; H04N 1/00233; H04N 2201/0094; H04N 2201/0039

(57) ABSTRACT

An image forming apparatus has a function to perform imaging of a web page provided by an external web server and provide a user with the web page. The image forming apparatus acquires contents information of the web page which is information related to the web page, and determines whether a predetermined discrimination condition is satisfied or not for each area of the web page, based on the acquired contents information. The image forming apparatus transmits the information related to the web page to an external server apparatus which differs from the web server in response to the determination result, and acquires information sent from the server apparatus after the transmitting. The image forming apparatus executes imaging of the web page based on the information which was sent from the server apparatus.

This application is based on Japanese Patent Application No. 2014-147920 filed with the Japan Patent Office on Jul. 18, 2014, the entire content of which is hereby incorporated by reference.

### BACKGROUND OF THE INVENTION

1. Field of the Invention

This invention relates to an image forming apparatus, a server apparatus, an image forming system, a control method of an image forming apparatus, a control method of a server apparatus, a control program of an image forming apparatus, and a control program of a server apparatus. In particular, this invention relates to an image forming apparatus, a server apparatus, an image forming system, a control method of an image forming apparatus, a control method of a server apparatus, a control program of an image forming apparatus, and a control program of a server apparatus being capable of generating images of web pages which external web servers provide, and providing users with the generated images.

2. Description of the Related Art

As image forming apparatuses, a MFP (Multi Function Peripheral) which has a scanner function, a facsimile function, a copying function, a function of a printer, a data transmitting function and a server function, etc., a facsimile device, a copying machine, a printer, and etc. are widely used. Recently, some image forming apparatuses have functions of a web browser. For example, web pages can be browsed by using a display panel installed in the image forming apparatus. The web pages can be printed as generated images.

In the image forming apparatus which has a function of a web browser, problems related to security may pose threats. For example, web pages may include data of harmful intent, acting as computer viruses. By browsing such web pages, user information registered in the image forming apparatus and information in a storing area may be in danger of leaking outside or being destroyed. To prevent such risks on security, various measures are taken in image forming apparatuses.

Document 1 below discloses an image forming apparatus which prepares a browser which is accessible to secret information in the apparatus and another browser which is not accessible to the secret information. Even though the URL for reading the secret information is known, the secret information can not be accessed unless the browser which has authority to access the secret information is used.

Document 2 below discloses a structure of a document management server for checking viruses, only for electronic files which have types of a high possibility of infection of computer viruses, in response to the types of the electronic file, when receiving electronic files sent by terminal devices.

Document 3 below discloses executing processes by an applet, upon confirming the applet is not infected with viruses by a virus detection unit, to prevent a printer from being invaded by computer viruses via the applet which processes printing data and to prevent font data, programs, or the like in the device from being destroyed.

Document 4 below discloses managing stored job data being divided and encrypted in storage devices in an isolated area, to prevent secret information from being leaked by an unauthorized access to user data in a printing process system and to prevent the user data from being tampered by infection with computer viruses etc. via networks.

[Document 1] Japan Patent Publication No. 2013-061818

[Document 2] Japan Patent Publication No. 2008-77231

[Document 3] Japan Patent Publication No. 11-119927

[Document 4] Japan Patent Publication No. 2005-178070

As for the security risks of image forming apparatuses above, various countermeasures may be conceived. These countermeasures have problems.

For example, one idea is installing an antivirus software which prevents harmful effect by computer viruses in an image forming apparatus, as doing for personal computers. However, installing such the software in an image forming apparatus takes a lot of trouble. In particular, in case that a lot of image forming apparatuses are used in an office, heavy workloads are needed. Even though an antivirus software can be installed in an image forming apparatus, there is the potential for processing speed deterioration for general behavior of the image forming apparatus, by executing the software at all times in the image forming apparatus. Hence, installing such the software in image forming apparatuses has a disadvantage.

Another idea is that an external server apparatus generates images (executes rendering) based on contents information of web pages and an image forming apparatus uses the images acquired from the server apparatus. However, when adopting the measures and the image forming apparatus utilizes an image which has a large data size (for example, a high resolution image, or a high quality image), a traffic amount of information from the server apparatus to the image forming apparatus becomes large, or it has a harmful effect on processing speed of the the image forming apparatus. Avoiding these problems may cause another problem in which the image forming apparatus should utilize an image which has a small data size (for example, a law resolution image, or a low quality image).

### SUMMARY OF THE INVENTION

This invention is to solve the problems. The object is to provide an image forming apparatus, a server apparatus, an image forming system, a control method of an image forming apparatus, a control method of a server apparatus, a control program of an image forming apparatus, and a control program of a server apparatus which have high-security performance and high-processing performance for various functions.

To achieve the above object, according to one aspect of the invention, an image forming apparatus comprising a processor which performs imaging of a web page provided by an external web server and provides a user with the web page, the processor is configured to: acquire contents information of the web page which is information related to the web page; determine whether a predetermined discrimination condition is satisfied or not for each area of the web page, based on the acquired contents information; transmit the information related to the web page to an external server apparatus which differs from the web server in response to the determination result; acquire information sent from the server apparatus after the transmitting; and execute imaging of the web page based on the acquired information which was sent from the server apparatus.

According to another aspect of the invention, a server apparatus comprising a processor which can communicate with an image forming apparatus that performs imaging of a web page provided by an external web server and provides a user with the web page, wherein the processor is configured to: receive information related to the web page transmitted from the image forming apparatus; acquire contents information of the web page based on the received information; perform partially imaging of the web page based on the acquired contents information; and send processed information to the image forming apparatus.

According to another aspect of the invention, an image forming system comprising an image forming apparatus which perform imaging a web page provided by an external web server and a server apparatus which can communicate with the image forming apparatus, wherein the image forming apparatus comprising a processor which is configured to: acquire information related to the web page; determine whether a predetermined discrimination condition is satisfied or not, based on the acquired information; transmit the information related to the web page to the server apparatus in response to the determination result; acquire information sent from the server apparatus after the transmitting; and execute imaging of the web page based on the acquired information which was sent from the server apparatus, wherein the server apparatus comprising a processor which is configured to: receive the information transmitted from the image forming apparatus; acquire contents information of the web page based on the received information; perform partially imaging of the web page based on the acquired contents information; and send processed information to the image forming apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of an image forming system, according to the first embodiment of this invention.

FIG. 2 shows a block diagram of a structure of each of devices in the image forming system.

FIG. 3 is for explanation pertaining to a function of utilizing a web page which is identified as safe.

FIG. 4 shows an example of a state in which a web page which is identified as safe is displayed on an operation panel.

FIG. 5 is for explanation pertaining to a function of utilizing a web page which is not identified as safe.

FIG. 6 shows an example of a state in which a web page which is not identified as safe is displayed on the operation panel.

FIG. 7 shows a flowchart of behavior of the MFP for a function of utilizing web pages.

FIG. 8 shows a flowchart of an example of a first safety determination process.

FIG. 9 shows a flowchart of another example of the first safety determination process.

FIG. 10 shows a flowchart of behavior of the cloud server for a function of utilizing web pages.

FIG. 11 shows a flowchart of an example of processing for each of areas.

FIG. 12 shows a flowchart of an example of a determination process for each of areas.

FIG. 13 shows a flowchart of behavior of the MFP for a function of utilizing web pages in the second embodiment.

FIG. 14 shows a flowchart for explanation of an example of behavior of a second safety determination process.

FIG. 15 shows the first example of the determination.

FIG. 16 shows the second example of the determination.

FIG. 17 shows the third example of the determination.

FIG. 18 shows the fourth example of the determination.

FIG. 19 shows a flowchart of behavior of the MFP for a function of utilizing web pages in the third embodiment.

FIG. 20 shows a flowchart of determination for each of areas by the MFP, according to the third embodiment.

FIG. 21 shows a flowchart of an example of behavior of the cloud server, according to the third embodiment.

### DESCRIPTION OF THE PREFERRED EMBODIMENTS

An example of an image forming system according to the embodiment of this invention will be explained in the following.

The image forming system uses so-called cloud computing technique. For example, outputting of an image forming apparatus located in a LAN (local area network) or the like of an intranet can be controlled by an external terminal device via Internet. For example, information acquired by the image forming apparatus in the intranet can be gotten and browsed by an external terminal device via Internet. At Internet side, cloud servers which can provide these services are placed. At the intranet side, for example, a gateway device for relaying communication with Internet is installed, so that the image forming apparatus can connect to Internet.

The image forming apparatus may be a black-and-white/color copying machine, a printer, a facsimile device, or the like. The image forming apparatus may be a MFP (Multi Function Peripheral) which has a scanner function, a copying function, a function of a printer, a facsimile function, a data transmitting function, and a server function. The scanner function is to read images of set documents and accumulate them in a HDD (Hard Disk Drive) or the like. The copying function is to print them on sheets or the like. The function of a printer is to perform printings on sheets based on instructions received from external terminal devices of PCs or the like. The facsimile function is to receive facsimile data from external facsimile devices or the like and accumulate them in a HDD or the like. The data transmitting function is to transmit and receive data with connected external devices. The server function makes stored data in a HDD or the like sharable for a plurality of users.

According to the embodiment, the image forming apparatus can generate images of web pages provided by the external web server being connected with Internet, and provide them for users. For example, imaged web pages (generated images of web pages) are displayed to users on a browser displayed on a display panel of the image forming apparatus. For example, imaged web pages are printed on sheets by the image forming apparatus ant output. For example, imaged web pages are transmitted to users by a communication method of e-mail,

### The First Embodiment

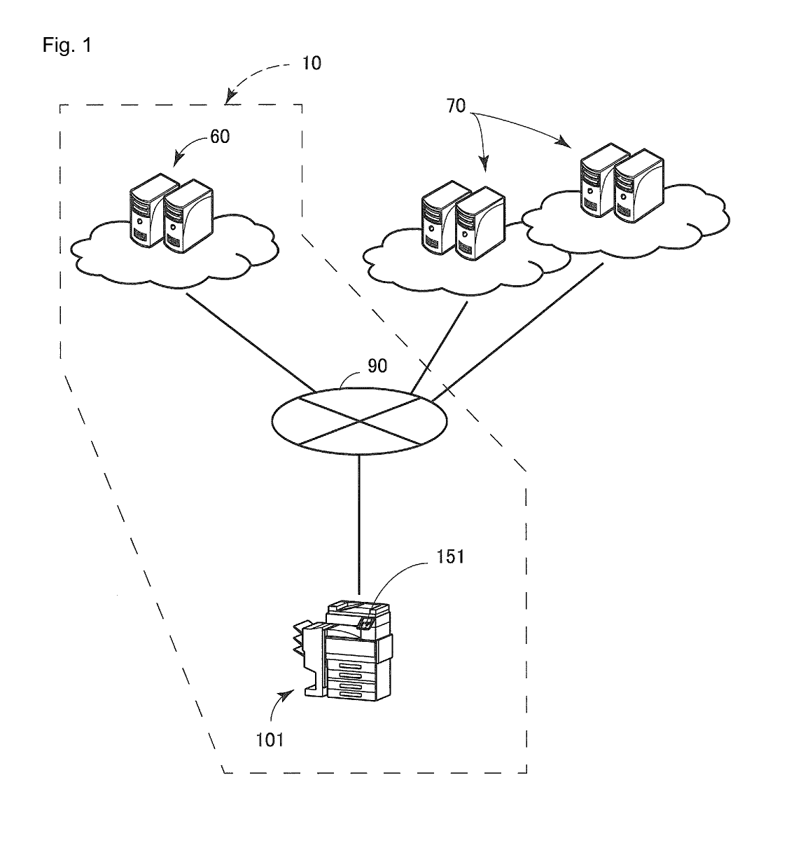

FIG. 1 shows a structure of an image forming system according to the first embodiment of this invention.

As seen from FIG. 1, image forming system 10 is a cloud system comprises a plurality of apparatuses connected with each other via Internet 90. More specifically, image forming system 10 includes a cloud server (an example of a server apparatus) 60 and a MFP (an example of an image forming apparatus) 101. Cloud server 60 and MFP 101 can communicate with each other via Internet 90, using a communication protocol of a HTTP or the like.

Cloud server 60 and MFP 101 can communicate with web servers 70 which are connected to Internet 90.

MFP 101 is connected with other equipments (for example, other image forming apparatuses, personal computers, server apparatuses) which form the intranet, via the LAN or the like. MFP 101 is connected with Internet 90 via the gateway device which relays communication between the intranet and Internet 90. The other equipments connected with the intranet are not shown in the Figures. MFP 101 is not limited to an apparatus connected with the intranet. For example, MFP 101 may be directly connected to Internet 90.

MFP 101 has an operation panel 151. Users can input various instructions into MFP 101, by using operation panel 151.

Cloud server 60 being used for the cloud system is only exemplified as a cloud system abstracted for each of functions in charge. Various structures can be conceived for structures of specific equipments to achieve practically the functions in the embodiment. For example a server other than cloud server 60 can be installed to manage communication between cloud server 60 and MFP 101 or the like. Cloud server 60 may be a single calculator. A plurality of calculators may work together to configure cloud server 60. One calculator or a plurality of calculators designed to work virtually may be used for each of calculators.

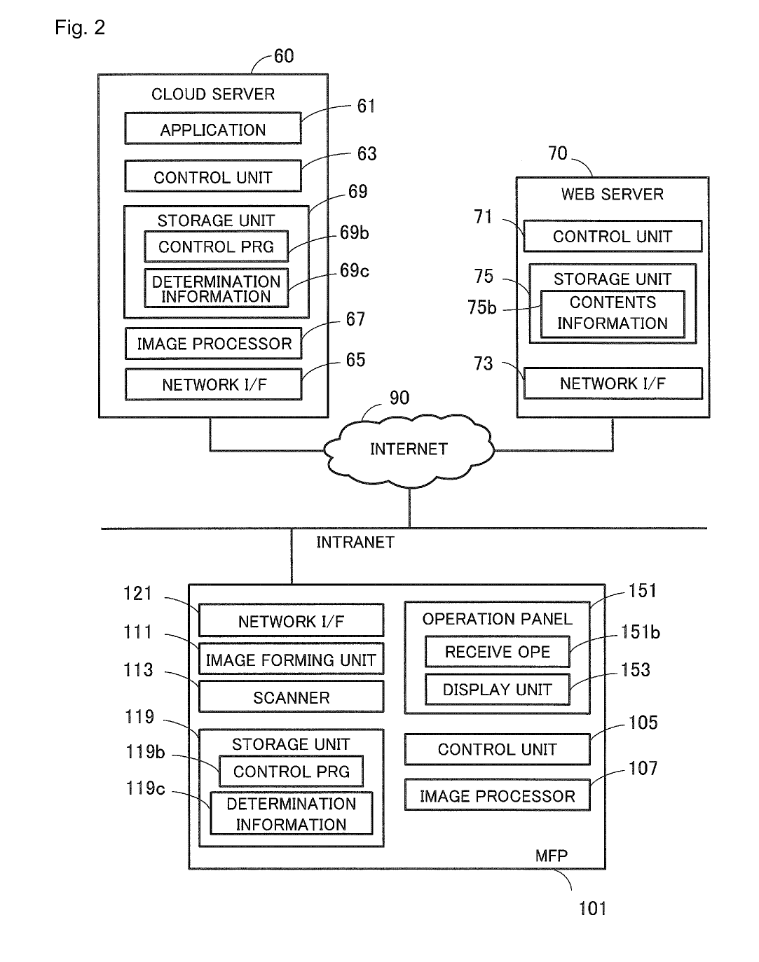

FIG. 2 shows a block diagram of a structure of each of devices in the image forming system 10.

As seen from FIG. 2, cloud server 60 has control unit 63, and cloud application 61 (an example of a control program, may be merely referred to as an “application”) which works under control of control unit 63. Cloud server 60 works applications 61 on a cloud application platform, and makes the application perform various control behaviors.

Cloud server 60 has network interface (I/F) 65, image processing unit 67, and storage unit 69.

Cloud server 60 is connected with Internet 90 via network interface 65. Herewith, cloud server 60 can communicate with the external device of MFP 101 or the like, via Internet 90.

Image processing unit 67 generates images (performs rendering) of web pages, based on contents information provided by web server 70. Image processing unit 67 performs the imaging based on control of control unit 63. Image processing unit 67 can perform imaging for each of areas in a web page. For example, the “area” means each of block level elements which form the web page. Image processing unit 67 may generate image for each of block level elements which are specific types and other elements in the web page.

Storage unit 69 stores control program 69b and determination information 69c. Since control unit 63 works based on control program 69b, various behaviors of cloud server 60 are performed. The determination information 69c will be explained in the following.

Web server 70 has a generic structure of a server apparatus which has a function for providing files in response to file acquire requests. For example, web server 70 comprises control unit 71, network interface 73, and storage unit 75. Web server 70 is connected with Internet 90 via network interface 73. Storage unit 75 stores contents information 75b of web pages. Web server 70 provides contents information 75b for external devices which issued a predetermined request, based on control of control unit 71. Herewith, the external device can generate images of web pages based on contents information 75b.

In the embodiment, contents information 75b means the following information. More specifically, contents information 75b is information being read when a web page is imaged. For example, the information is described by a HTML, a CSS (cascade style sheets), or other languages, and indicates images and videos.

MFP 101 roughly comprises image forming unit 111, scanner unit 113, and network interface 121. More specifically, MFP 101 performs printing jobs by image forming unit 111 to form images on sheets and output them. MFP 101 can read documents as image data by scanner unit 113 and perform various image processings. MFP 101 is connected with Internet 90 via network interface 121.

MFP 101 has control unit 105, image processing unit 107, storage unit 119, and operation panel 151.

For example, control unit 105 is a CPU to execute various control behaviors for each part of MFP 101. More specifically, MFP 101 executes various behaviors under control of control unit 105.

Image processing unit 107 can generate images of web pages, based on contents information 75b or the like acquired from web server 70. Image processing unit 107 generates images based on control of control unit 105.

Storage unit 119 stores various data which are used when MFP 101 works. Storage unit 119 is used to achieve a BOX function. More specifically, storage unit 119 stores user data for each user of MFP 101. Users can print the stored user data on sheets or transmit the data to another user, by reference to storage unit 119.

For example, storage unit 119 stores control program 119b. Control unit 105 works based on control program 119b, so that various behaviors of MFP 101 are performed.

Storage unit 119 stores determination information 119c. Determination information 119c will be explained in detail, in the following.

Operation panel 151 has operation receiving unit 151b and display unit 153. For example, operation panel 151 is a touch panel using a liquid crystal display as display unit 153. Operation panel 151 has a plurality of operation buttons. Operation buttons and the touch panel behave as operation receiving unit 151b.

When a user performs operations on operation panel 151 (more specifically, the operation buttons or the touch panel are operated), the operations are received by operation receiving unit 151b. Control unit 105 executes various controls in response to the received operations.

[An explanation for a Function of Utilizing Web Pages]

MFP 101 has a function for utilizing web pages. The function for utilizing web pages is performed using operation panel 151, control program 119b being executed by control unit 105.

For example, the function for utilizing web pages is as follow. Control unit 105 generates an image of a web page designated by a user as a browsing object, and displays it on operation panel 151. Alternatively, control unit 105 generates an image of a web page specified by a user and outputs it by image forming unit 111. Alternatively, control unit 105 generates an image of a web page specified by a user and transmits it to another user or the like. More specifically, the imaged web page is provided to the user by performing the function for utilizing web pages.

A user can specify a web page by performing operations to identify a URI (Uniform Resource Identifier) of the web page which is a utilizing object using operation panel 151, for example. More specifically, the URI is identified by directly inputting the URI as a character string, specifying the web page registered as a so-called bookmark, or selecting a hyperlink which is included in the browsing web page or the like on operation panel 151.

In the embodiment, MFP 101 determines whether the utilized web page is safe or not. MFP 101 performs different behaviors in response to the determination result.

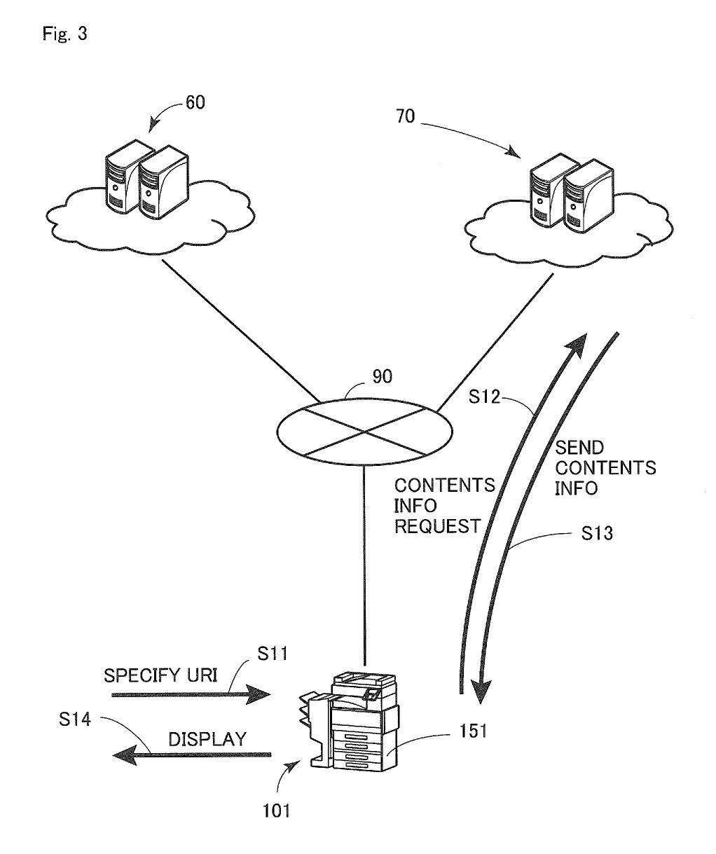

FIG. 3 is for explanation pertaining to a function of utilizing a web page which is identified as safe.

As seen from FIG. 3, it is assumed that a URI of a web page that will be identified as safe is specified by a user at step S11. When the URI is specified, MFP 101 (control unit 105 of MFP 101) determines whether the web page is safe or not.

In case that the web page is identified as safe, an acquire request (GET) for information (contents information 75b) identified by the URI is transmitted from MFP 101 to web server 70 identified by the URI, at step S12.

At step S13, web server 70 transmits contents information 75b to MFP 101, in response to the acquire request.

MFP 101 generates an image of the web page, based on the received contents information 75b. At step S14, MFP 101 displays the imaged web page on display unit 153 of operation panel 151. Herewith, the web page is provided for the user.

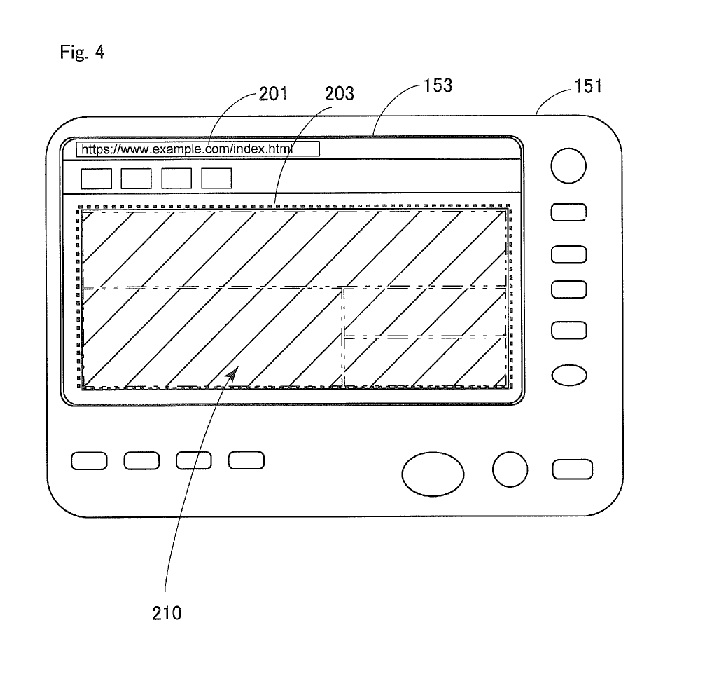

FIG. 4 shows an example of a state in which a web page which was identified as safe is displayed on an operation panel 151.

As seen from FIG. 4, a browser screen is displayed on display unit 153 of operation panel 151. The browser screen includes operation portion 201 and display portion 203. An address bar which displays a URI or the like is provided in operation portion 201. In display portion 203, contents of the web page are displayed. The web page displayed on display portion 203 was imaged, based on the contents information.

In FIG. 4, the area with hatched lines indicates the imaged web page 210. In FIG. 4, each area surrounded by alternate long and two short dashes lines indicates each area included in web page 210. The whole area of web page 210 was imaged by image processing unit 107 of MFP 101, as shown by surrounding broken lines in FIG. 4.

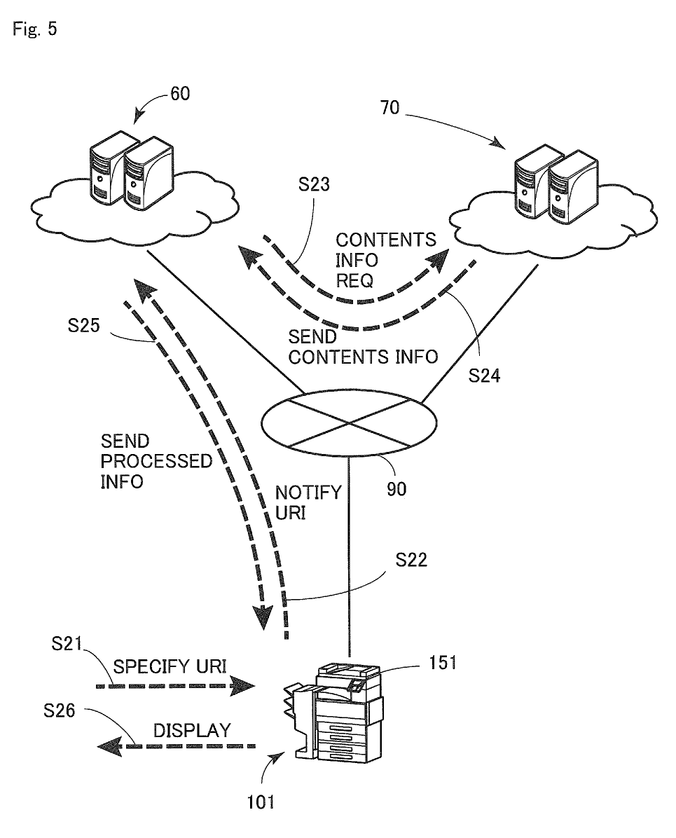

FIG. 5 is for explanation pertaining to the function of utilizing a web page which is not identified as safe.

As seen from FIG. 5, it is assumed that a URI of a web page that will not be identified as safe is specified by a user at step S21. When the URI is specified, MFP 101 determines whether the web page is safe or not.

In case that the web page is not identified as safe, the URI is transmitted from MFP 101 to cloud server 60, at step S22. More specifically, in this instance, information related to the web page is transmitted from MFP 101 to cloud server 60.

At step S23, cloud server 60 (control unit 63 of cloud server 60) requests web server 70 identified by the URI to send contents information 75b identified by the URI, based on the received URI.

At step S24, web server 70 transmits contents information 75b to cloud server 60, in response to the request.

Cloud server 60 determines whether each of areas in the web page is safe or not, based on the acquired contents information 75b. In case that an area is not safe, cloud server 60 generates the image of the area, based on contents information 75b. Cloud server 60 performs the processes for each of areas. Cloud server 60 processes contents information 75b, so that the web page is imaged by the imaged information and the other information.

At step S25, cloud server 60 transmits the processed information to MFP 101.

MFP 101 generates an image of the web page, based on the received information (information processed on cloud server 60). At step S26, MFP 101 displays the imaged web page on display unit 153 of operation panel 151. Herewith, the web page is provided to the user.

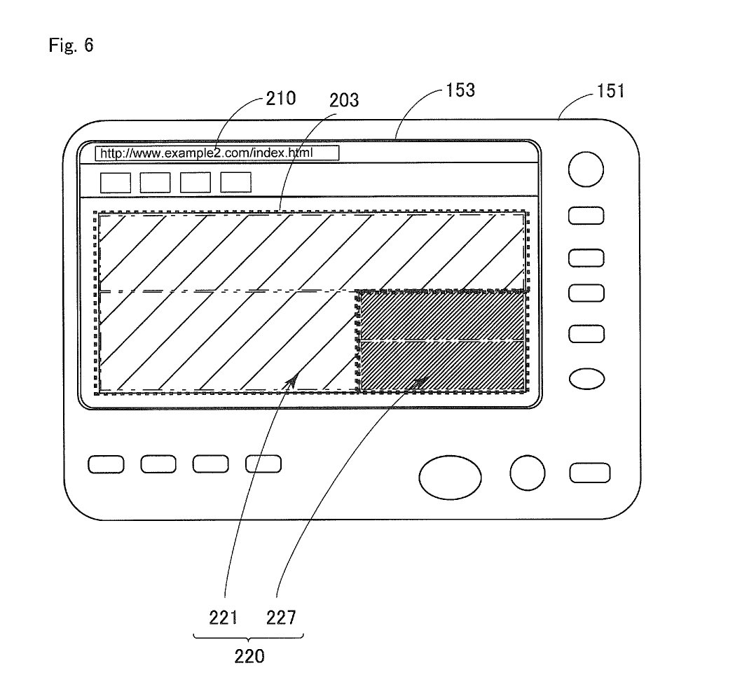

FIG. 6 shows an example of a state in which a web page which was not identified as safe is displayed on the operation panel 151.

In FIG. 6, the area with hatched lines indicates the imaged web page 220. In FIG. 6, each area surrounded by alternate long and two short dashes lines indicates each area included in web page 210.

As shown by the surrounding broken line in FIG. 6, web page 220 is divided into safe area 221 and not safe area 227. Not safe area 227 is imaged by cloud server 60 and transmitted to MFP 101. MFP 101 generates the image based on information processed by cloud server 60. Then, the web page 220 is imaged so that not safe area 227 imaged is located at the location of the not safe area 227 indicated by the original contents information 75b. More specifically, web page 220 is imaged in a similar way that MFP 101 directly generates an image of web page 220 based on contents information 75b.

Next, the flow of such the processing will be explained.

[Explanation for Behavior of MFP 101 Related to a Function for Utilizing Web Pages]

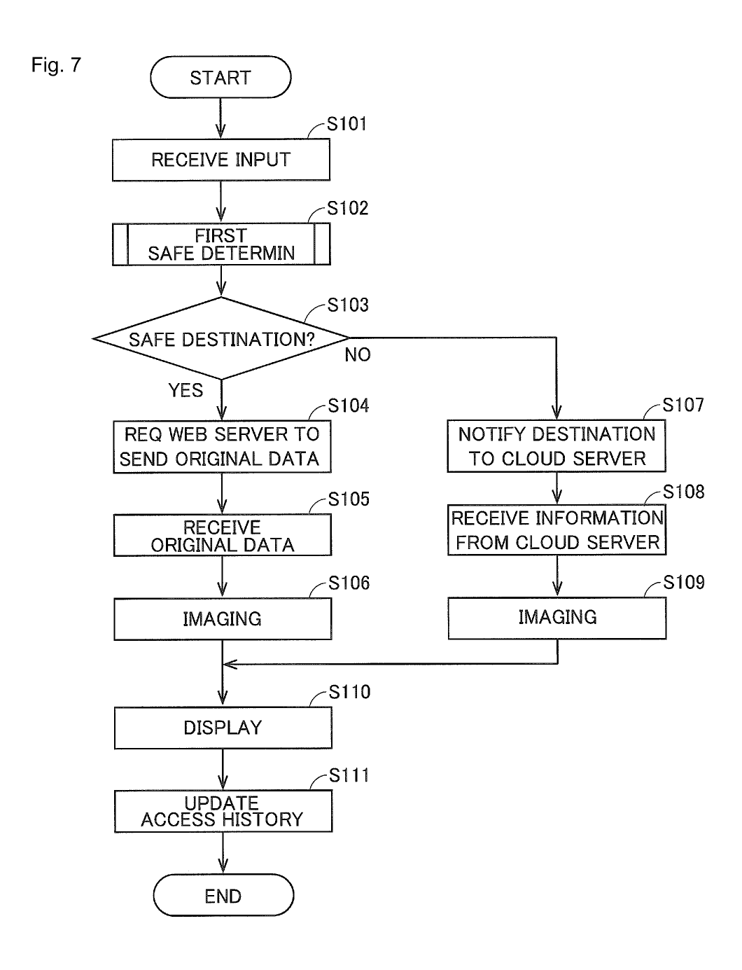

FIG. 7 shows a flowchart of behavior of the MFP 101 for the function of utilizing a web page.

Control unit 105 controls each part of MFP 101, so that the processes shown in FIG. 7 are performed. It is assumed that a user instructs to display a web page as an image on display unit 153 (an embodiment of utilizing a web page).

As shown in FIG. 7, at step S101, control unit 105 receives an operation input from a user. At this time, an operation for specifying a URI related to a web page is received from the user. Herewith, control unit 105 acquires information of the URI specified by the user.

At step S102, control unit 105 performs the first safety determination process. In the first safety determination process, whether the predetermined discrimination condition is satisfied or not is determined based on the acquired URI. The predetermined discrimination condition is a criterion to determine whether a web page corresponding to a URL is safe or not (whether the destination is safe or not).

At step S103, whether the web page corresponding to the URI, as the web page specified by the user is safe or not is determined. In the first safety determination process, in case that the predetermined discrimination condition is satisfied, the web page is identified as safe.

In case that the web page is identified as safe at step S103, the process of step S104 is performed. More specifically, control unit 105 requests web server 70 which provides the contents information to transmit the information, to acquire the contents information (original data) identified by the URI. Herewith, the contents information is transmitted from web server 70 to MFP 101.

At step S105, control unit 105 receives the transmitted contents information.

At step S106, control unit 105 performs the imaging process based on the contents information. Herewith, the image of the web page is generated.

On the other hand, in case that the web page is not identified as safe at step S103, the processes of steps S107 to S109 are performed, as substitute for the above processes of steps S104 to S106. More specifically, MFP 101 does not directly access web server 70. MFP 101 accesses via cloud server 60.

At step S107, control unit 105 informs cloud server 60 of information related to the web page. For example, MFP 101 sends the URL which the user input as the destination information of the web page to cloud server 60.

When the URI is transmitted to cloud server 60, cloud server 60 receives and processes the contents information of the web page indicated by the URI, as described below. Cloud server 60 sends the processed information to MFP 101.

At step S108, control unit 105 receives the processed information transmitted from cloud server 60.

At step S109, control unit 105 performs the imaging process based on the processed information received. Herewith, the image of the web page is generated.

After the imaging process at step S106 or step S109, the process of step S110 is executed. More specifically, at step S110, control unit 105 displays the imaged web page (the image showing the web page) on display unit 153.

At step S111, control unit 105 updates the access history. More specifically, in the embodiment, the information of the web page utilized based on the function for utilizing web pages is managed as the access history, based on control of control unit 105. The access history is recorded in storage unit 119 as determination information 119c, for example. As the access history, for example, information of the URI of the web page, the access time and date, etc. are recorded. The access history is recorded when both web server 70 is directly accessed by MFP 101 (steps S104 and S105) and web server 70 is accessed via cloud server 60 (steps S107 and S108). The access history may be recorded only when web server 70 is directly accessed by MFP 101.

After the process of step S111, the sequence of actions is completed.

A image of a web page may be printed out on a sheet, or attached to e-mail and transmitted to another user (Web pages may be utilized in other embodiments), when a user performs predetermined operations during the web page is displayed on display unit 153, or the URI is input after predetermined instructions were performed.

[Explanation of the First Safety Determination Process]

According to the first safety determination process, whether the web page is safe or not is determined based on the URI of the web page, for example.

More specifically, storage unit 119 stores determination information 119c, as the information related to the access history and a white list which registers domain names recognized as safe destinations, beforehand. The information related to the access history is updated as presented above, whenever the function for utilizing a web page is executed.

Control unit 105 determines whether the web page is safe or not, by determining whether the specified URI satisfies the predetermined discrimination conditions or not. In the embodiment, for example, the determination is done based on 2 types of discrimination conditions. More specifically, the predetermined discrimination conditions include a condition which requires that the web page has been accessed (a condition related to the access history). For example, the predetermined discrimination conditions include a condition which requires that the web page matches the white list configured beforehand (a condition related to the white list).

The predetermined discrimination conditions may include a condition requires the domain to which the web page belongs has been accessed, for example.

The predetermined discrimination conditions may include a condition which requires that the domain to which the web page belongs matches the white list configured beforehand. The predetermined discrimination conditions may include a condition which requires that the web page or the domain to which the web page belongs does not match the black list configured beforehand. In this instance, determination information 119c, as the black list which records domain names which are not identified as safe should be stored beforehand.

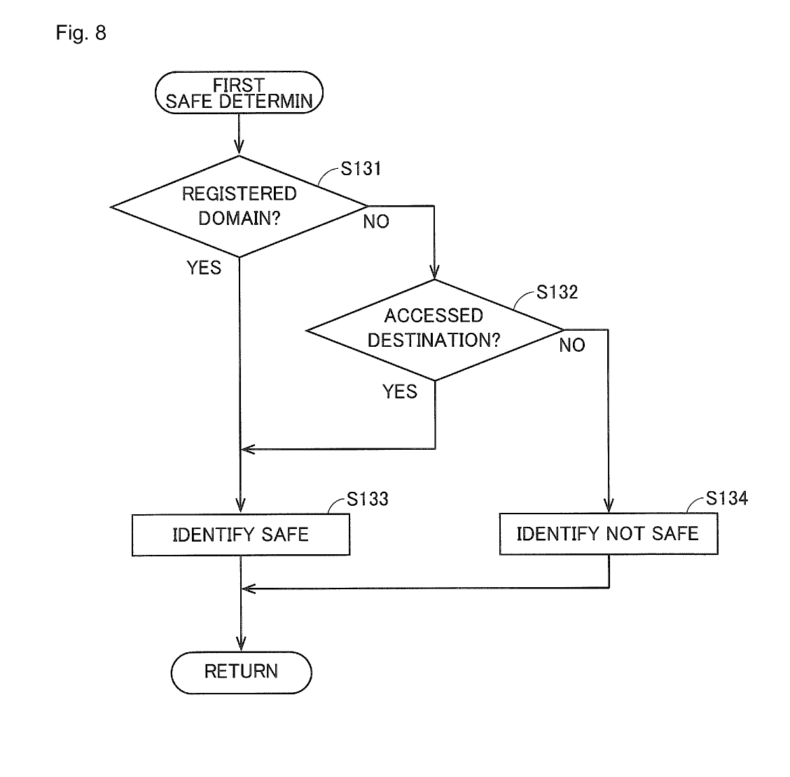

FIG. 8 shows a flowchart of an example of a first safety determination process.

As seen from FIG. 8, at step S131, control unit 105 determines whether the web page is of the domain registered beforehand, based on the URI. The determination is done based on the white list registered as determination information 119c.

If the domain is not registered at step S131, control unit 105 determines whether the destination has been accessed or not based on the URI at step S132. The determination is done based on determination information 119c recorded for the access history.

In case that the domain is registered beforehand at step S131, or the destination has been accessed at step S132, control unit 105 determines that the web page is safe at step S133.

On the other hand, the destination has not been accessed at step S132, control unit 105 determines that the web page is not safe at step S134.

After the determination of step S133 or step S134, control unit 105 returns to the the above processes.

Therefor, the web page is identified as safe or not, based on the URI. The determination of safety can easily and quickly be executed.

A web page may be identified as safe only when the domain is registered beforehand and the destination has been accessed (when the above both two conditions are satisfied).

The determination is not limited to the method based on the two types of conditions related to the white list and the access history. For example, the determination may be performed based on only a condition related to the white list. The determination may be performed based on only a condition related to the access history.

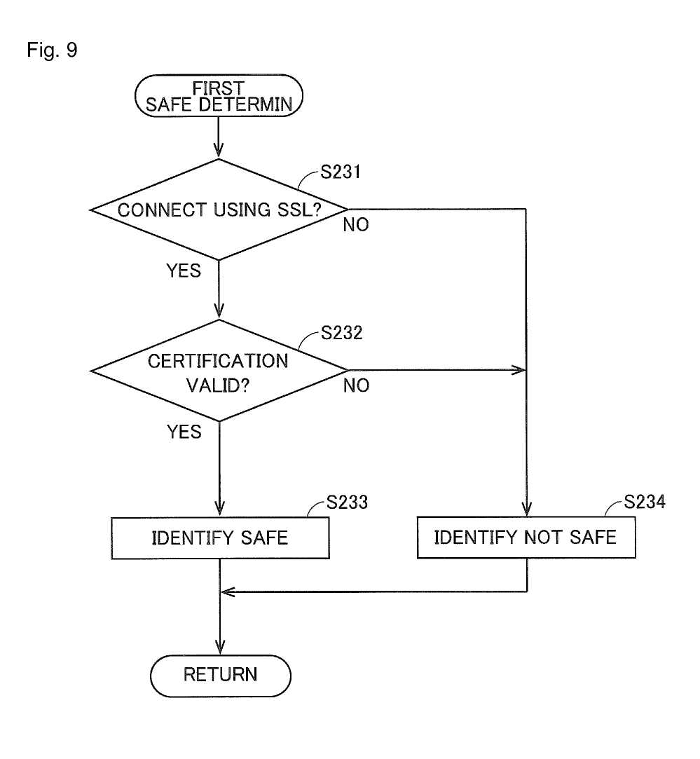

FIG. 9 shows a flowchart of another example of the first safety determination process.

The first safety determination process is not limited to the above-mentioned process as shown in FIG. 8. For example, the predetermined discrimination condition may include a condition related to a communications protocol to acquire contents information of the web page.

For example, it is assumed that a scheme of the URI of the web page utilizes a SSL (Secure Sockets Layer) and the certification of web server 70 which provides the web page is signed by a proper certificate authority are ruled as predetermined discrimination conditions.

More specifically, as seen from FIG. 9, at step S231, control unit 105 determines whether the connection uses a SSL or not, based on the URI. More specifically, for example, in case that the scheme of the URI is HTTPS (Hypertext Transfer Protocol Secure), the connection is identified as a connection which uses a SSL. For example, in case that the scheme of the URI is HTTP (Hypertext Transfer Protocol), the connection is not identified as a connection which uses a SSL.

In case that the connection is identified as of a SSL at step S231, whether validation of the server certification succeeded or not is determined at step S232. In case that the server certification is based on a proper certificate authority, the validation is determined as success.

When the validation succeeded at step S232, the web page is identified as safe at step S233.

On the other hand, in case that the connection is not identified as of a SSL at step S231 or in case that the validation is not determined as success at step S232, the web page is not identified as safe at step S234.

After the determination of step S233 or S234, control unit 105 returns to the above processes.

The determination can be easily performed, by determining whether the web page is safe or not based on the communications protocol of the specified URI. As for web server 70 specified as a new connection destination, the safety can be determined on a reasonable basis.

[Explanation of Behavior of Cloud Server 60 for a Function to Utilize Web Pages]

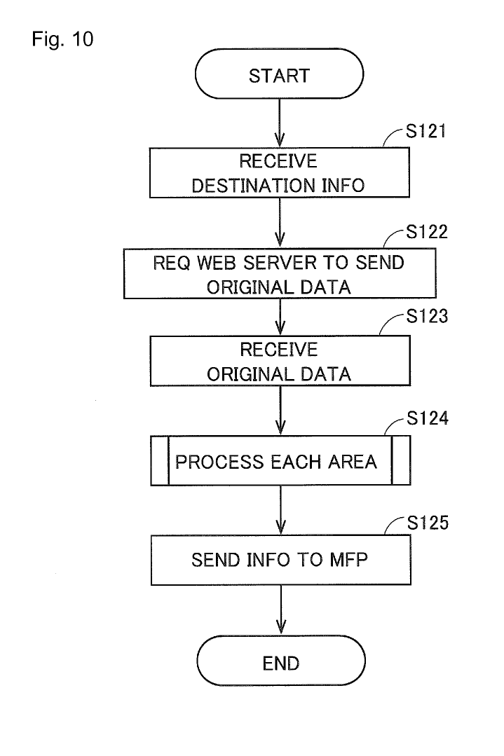

FIG. 10 shows a flowchart of behavior of the cloud server 60 for a function of utilizing web page.

The process presented in FIG. 10 is performed by control unit 63 of cloud server 60 controlling each part of cloud server 60. It is assumed that a URI of a web page to be utilized is transmitted from MFP 101 to cloud server 60, as presented above.

At step S121, control unit 63 receives the URI transmitted from MFP 101.

At step S122, control unit 63 requests web server 70 which provides the contents information to send information, so that control unit 63 acquires the contents information (original data) identified by the received URI. Herewith, web server 70 sends the contents information to cloud server 60.

At step S123, control unit 63 receives the contents information transmitted from the web server 70.

At step S124, control unit 63 analyzes the received contents information, and performs processes for each area in the web page.

At step S125, control unit 63 transmits information after the processes for each area to MFP 101. At this time, control unit 63 converts contents information, so that generated images are displayed for the areas which were not identified as safe. Control unit 63 transmits the information after the processing.

More specifically, for example, the contents information is converted by using an inter-frame format, to display different frame information at the areas which are not identified as safe. In the frame, the generated image is placed. The processed information includes, for example, a HTML formatted file in which the structure of the web page or the like is described and generated images. The processed information is imaged by using the generated image. Then, the same image as for image directly generated by imaging primary contents information can be acquired.

By the completion of the process of step S125, the sequence of the processes is over.

[Explanation of Processes for Each Area]

In the determination process for each area, the area structure of the web page is analyzed based on contents information of the web page. Whether an area is safe or not is determined for each area of the web page. In case that the area is not safe, imaging process is performed to the area (area imaging process).

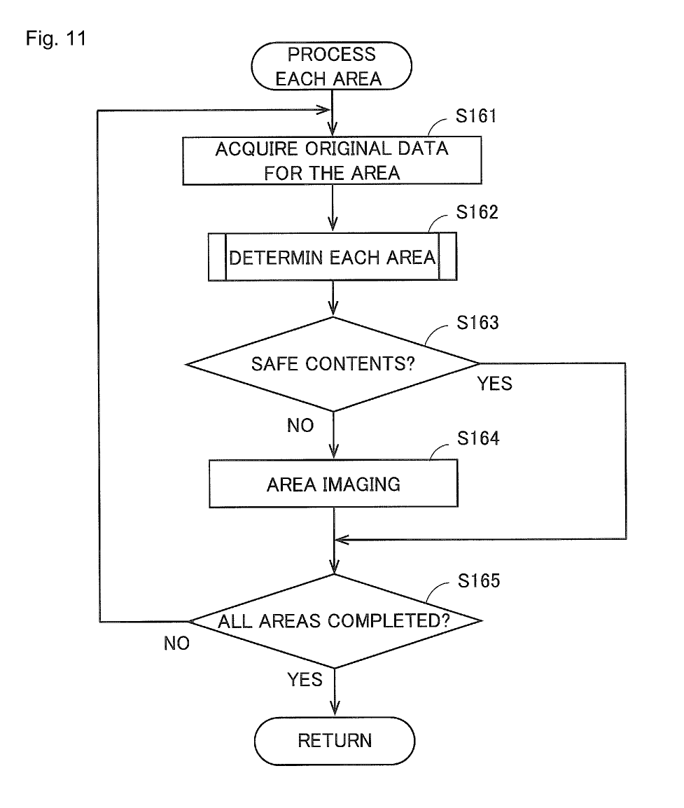

FIG. 11 shows a flowchart of an example of processing for each of areas.

As seen from FIG. 11, at step S161, control unit 63 identifies an area which is to be the next processing area in the web page. Control unit 63 acquires the contents information (original data) for the area to be processed.

At step S162, the determination process for each area is executed. Herewith, determination whether the contents is safe or not for the area to be processed is executed.

At step S163, whether the area to be processed is determined as safe contents or not is confirmed. In case that it is determined as safe contents at step S163, control unit 63 directly proceeds to the process of step S165.

In case that it is not determined as safe contents at step S163, control unit 63 proceeds to the process of step S164. More specifically, control unit 63 executes the imaging process for the area to be processed. The imaging process is executed based on the contents information of the area to be processed.

After the completion of the above process for the area to be processed, whether all areas which form the web page were processed or not is determined at step S165. When there is an unprocessed area, the area will be processed in step S161 and the following steps.

When it is confirmed that the all areas were processed at step S165, control unit 63 gets back to the above process.

The determination process for each area is performed based on the determination result of whether the predetermined discrimination condition is satisfied or not in the following manner, for example. The predetermined discrimination condition may include a condition related to the URI of contents in the area of the web page, for example.

For example, in the embodiment, storage unit 69 stores a list (white list) of domains which can be identified as safe (allowed domains) beforehand, as determination information 69c.

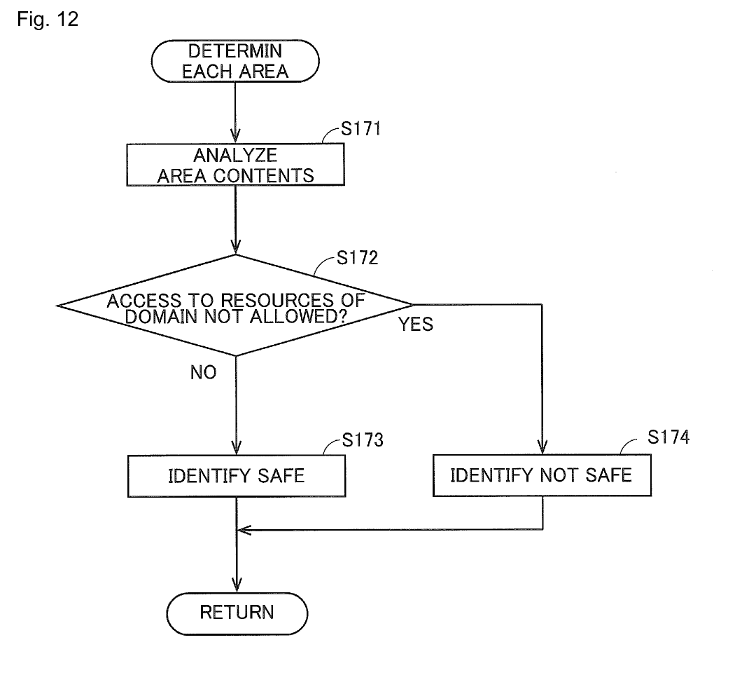

FIG. 12 shows a flowchart of an example of determination processes for each of areas.

As seen from FIG. 12, at step S171, control unit 63 analyzes the contents information of the part for the area to be processed. More specifically, the URI of the resource used when imaging of the processing area is extracted, for example.

At step S172, control unit 63 determines whether a resource of a domain which is not an allowed domain configured in determination information 69c is to be accessed or not, when the imaging of the processing area. The determination is performed for the extracted URI.

In case that a domain which is not allowed is not to be accessed at step S172, control unit 63 determines that the contents of the area is safe at step S173.

On the other hand, in case that a domain which is not allowed is to be accessed at step S172, control unit 63 determines that the contents of the area is not safe at step S174.

After the process of step S173 or step S174, control unit 63 gets back to the above process for each area.

The predetermined discrimination condition in the determination process for each area is not limited to the above condition. A plurality of discrimination conditions may be set. The determination may be performed, based on whether the one of the conditions is satisfied or not, or whether all the conditions are satisfied or not.

For example, the predetermined discrimination condition may include a condition related to the communications protocol for acquiring a resource of contents or the like in the web page. In this instance, the URIs of the resources used when imaging of the processing area are extracted, for example. In case that all the schemes for the URIs are HTTPS, the contents in the area is identified as safe. On the other hand, in case that at least one of schemes for the URIs is not HTTPS, the contents in the area is not identified as safe.

Namely, whether the area to be processed is safe or not is determined, based on the communication protocol for acquiring the resources. It makes the determination easy. Whether a resource which has not been accessed etc. is safe or not can be determined on a reasonable basis.

The predetermined discrimination condition may include a condition related to attributes of contents in an area of a web page. For example, whether the area to be processed includes an element of which the type is predetermined (an element indicating video, an element indicating sound, or the like) or not is determined. In case that such the element is included, the contents of the area are not identified safe. The contents of the area may be not identified as safe, in case that predefined areas include an element indicating a predetermined type of structure of a web page (a frame element or the like). The contents of the area may be not identified as safe, in case that predefined areas include an element or information related to simple programs, i.e. script elements, script description, or the like.

The determination can be easily performed by identifying safe or not of the contents of the area to be processed, based on conditions related to attributes of the contents. The contents having attributes which may carry a high risk can certainly be identified as no safe. For example, character areas and image areas are identified as safe. Video area can easily be identified as an area with no safe.

As expressed above, in the first embodiment, the contents information is received by cloud server 60, as for a web page which was not indentified as safe. Then, cloud server 60 performs imaging of no safe areas, and the information of the web page is transmitted to MFP 101. MFP 101 performs imaging of the web page, based on the imaged information and information of the areas which were identified as safe. Hence, direct imaging by MFP 101 can be avoided, when utilizing the web page which may be no safe. MFP 101 can improve performance of security.

When utilizing a safe web page, MFP 101 performs imaging as usual without cloud server 60. Hence, the volume of communication between MFP 101 and cloud server 60 can be drove down. When utilizing a web page which may be no safe, all the imagings are not performed by cloud server 60, and the parts of the page are imaged. More specifically, only the areas which were determined as no safe of the web page are imaged. Namely, MFP 101 performs imaging to the extent that security is ensured, if at all possible. Hence, the volume of communication between MFP 101 and cloud server 60 can be drove down. MFP 101 can perform imaging of the web page with high imaging quality by using safe information processed by cloud server 60.

### The Second Embodiment

The basic structure and basic behavior of an image forming system in the second embodiment is as same as the first embodiment. The explanation will not be repeated. In the second embodiment, a part of behavior performed by MFP 101 for a function of utilizing web pages is different from the first embodiment.

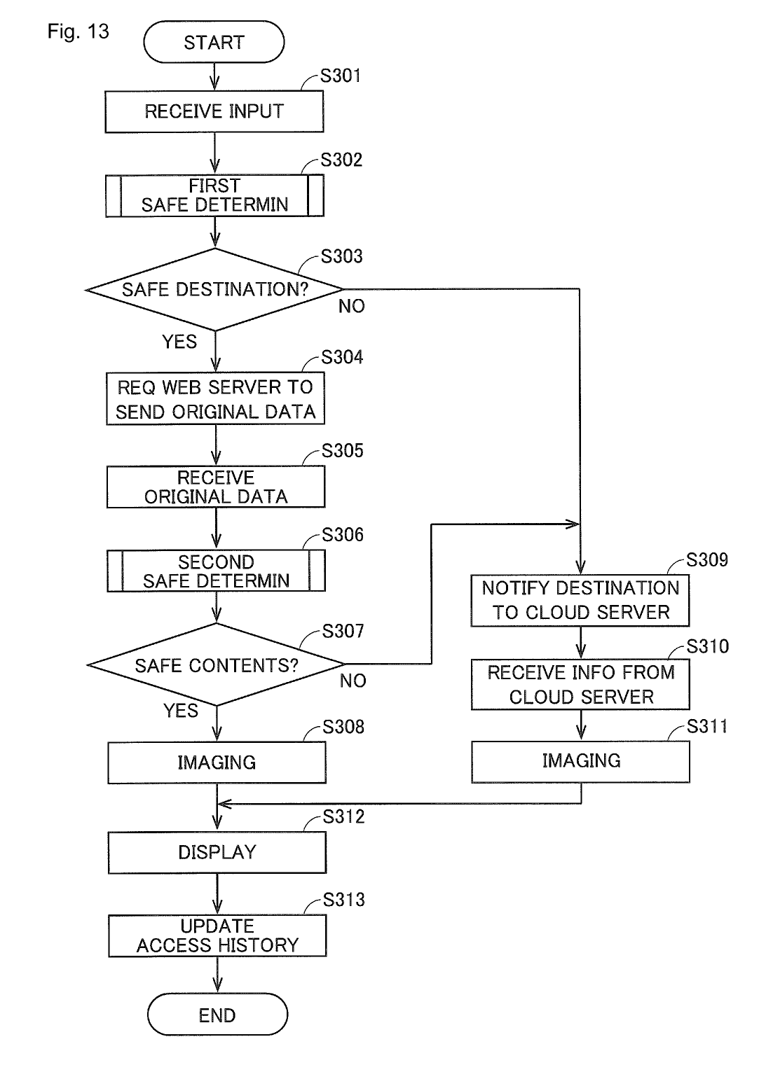

FIG. 13 shows a flowchart of behavior of the MFP 101 for a function of utilizing web pages in the second embodiment.

In FIG. 13, the processes of steps S301 to S305 are performed similarly as steps S101 to S105 of FIG. 7. The processes of steps S308 to S313 are performed similarly as steps S106 to S111 in FIG. 7.

More specifically, in this embodiment, in case that a web page is identified as safe based on the result of the first safety determination process, the second safety determination process is performed for the web page.

More specifically, when control unit 105 of MFP 101 receives contents information transmitted from web server 70 (step S305), the process of step S306 is executed. More specifically, at step S306, the second safety determination process is performed. By the second safety determination process, the web page is identified whether safe or not.

At step S307, control unit 105 confirms whether the web page is identified as safe (the contents is identified as safe) or not.

In case that the web page is identified as safe at step S307, imaging processes are performed in MFP 101 based on received contents information at step S308.

On the other hand, in case that the web page is not identified as safe at step S307, the processes of step S309 and the following steps are executed. More specifically, the processes as same as the processes in case that the web page is not identified as safe by the first safety determination process are executed. More specifically, control unit 105 informs cloud server 60 of information related to the web page. Control unit 105 receives information processed by cloud server 60.

In the second safety determination process, whether the predetermined discrimination condition is satisfied or not is determined based on the acquired contents information of the web page. In response to the determination result, whether the web page is safe or not is identified. Namely, whether the web page is safe or not is determined, based on the contents information of the web page.

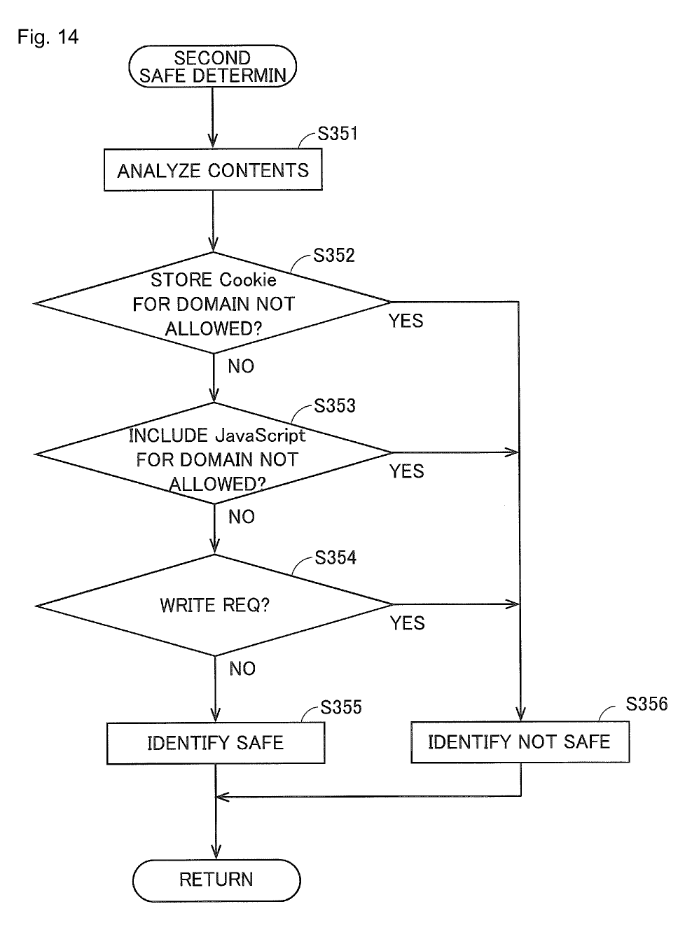

FIG. 14 shows a flowchart for explanation of an example of behavior of the second safety determination process.

In the example shown in FIG. 14, it is assumed that the following three conditions are configured as the predetermined discrimination conditions.

At step S351, control unit 105 analyzes contents information of the web page. More specifically, control unit 105 extracts URIs of resources used when imaging of the web page, for example.

At step S352, control unit 105 determines the presence or absence of a request of storing Cookies for a domain other than allowed domains, based on the contents information. Whether the domain is allowed or not can be determined based on determination information 119c stored in storage unit 119, for example as explained in the above first embodiment.

At step S353, control unit 105 determines whether the web page includes script files (for example, JavaScript, but not limited to it) specified by a URI other than the allowed domains or not, based on the contents information.

At step S354, control unit 105 determines whether an access to resources in MFP 101 is requested or not in accordance with the imaging of the web page, based on the contents information (For example, whether a writing of information into storage unit 119 is requested or not in accordance with specifications of WebStorage of HTML5 or the like).

In case that all the three discrimination conditions in which there is not a store request at step S352, such the script file is not included at step S353, and an access is not requested at step S354 are satisfied, control unit 105 determines the contents of the web page is safe at step S355.

On the other hand, one of the above three discrimination conditions is not satisfied, control unit 105 determines the contents of the web page is not safe at step S356.

After the process at step S355 or step S356, control unit 105 returns to the the above processes shown in FIG. 13.

In the second safety determination process, only a discrimination condition may be set. A plurality of discrimination conditions may be set. The determination may be performed, based on whether the one of the conditions is satisfied or not, or whether all the conditions are satisfied or not.

The predetermined discrimination conditions are not limited to the above conditions. Various sorts of predetermined discrimination conditions can be adopted. For example, the predetermined discrimination condition may be same as the predetermined discrimination condition in the determination process for each area of the first embodiment. More specifically, the determination may be performed based on the URI of the contents (the resource) in the web page. The determination may be performed based on communication protocols for acquiring contents in the web page. The determination may be performed based on attributes of contents in the web page. In the determination process for each area, such the determination can be performed based on contents information of the area to be processed. On the other hand, in the second safety determination process, the determination can be performed by the similar discrimination condition, based on contents information of the entire web page.

In the second safety determination process, whether the web page is safe or not may be determined by determining whether the predetermined discrimination condition is satisfied or not, based on a part of the contents information of the web page. For example, whether the web page is safe or not may be determined, based on a HTML header description in the contents information of the web page.

[Explanation of Determination Examples]

Determination examples of the second safety determination process will be explained, with exemplifying specific contents information. The second safety determination process will be explained in the following. In the determination process for each area, the determination can be done similarly.

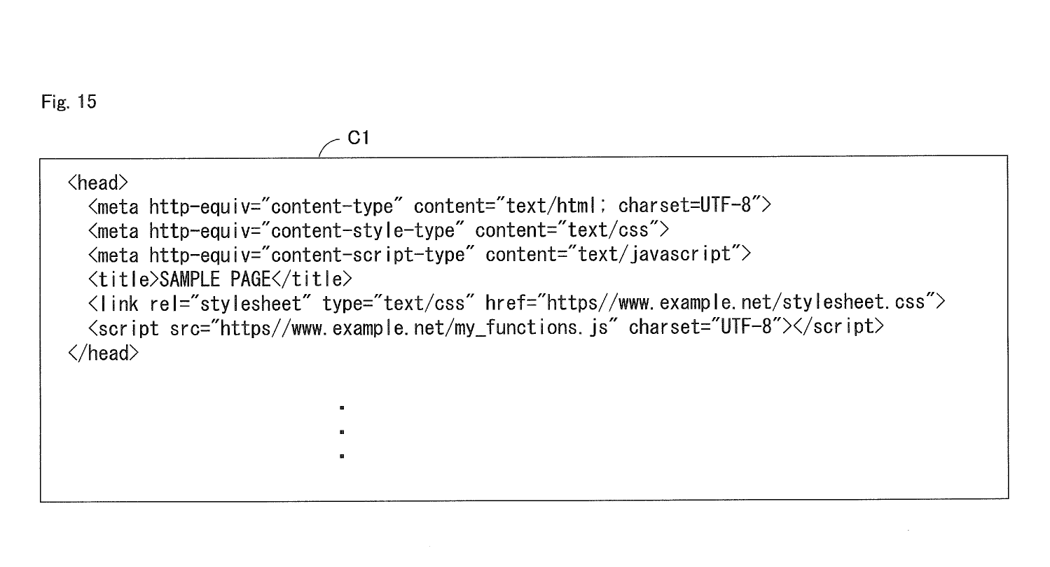

FIG. 15 shows the first example of the determination.

In FIG. 15, an example of header contents C1 in a HTML file of the web page as contents information is shown. As seen from the URI in contents C1, the domain (example.net) of the CSS (cascading style sheets) file and the JS file, which differs from the domain at which contents C1 are stored is specified, for example. In such the case, the contents of the web page (or the area related to the description) are identified as no safe.

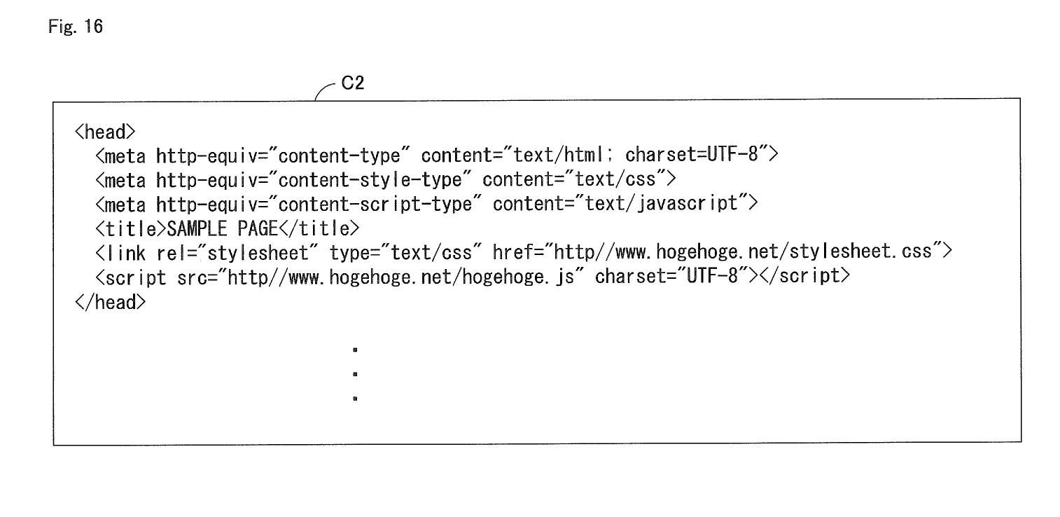

FIG. 16 shows the second example of the determination.

In FIG. 16, an example of header contents C2 in a HTML file of the web page as contents information is shown. As seen from the URI of the CSS file and the JS file in contents C2 for example, a SSL is not used as the communications protocol. In such the case, the contents of the web page (or the area related to the description) are identified as no safe.

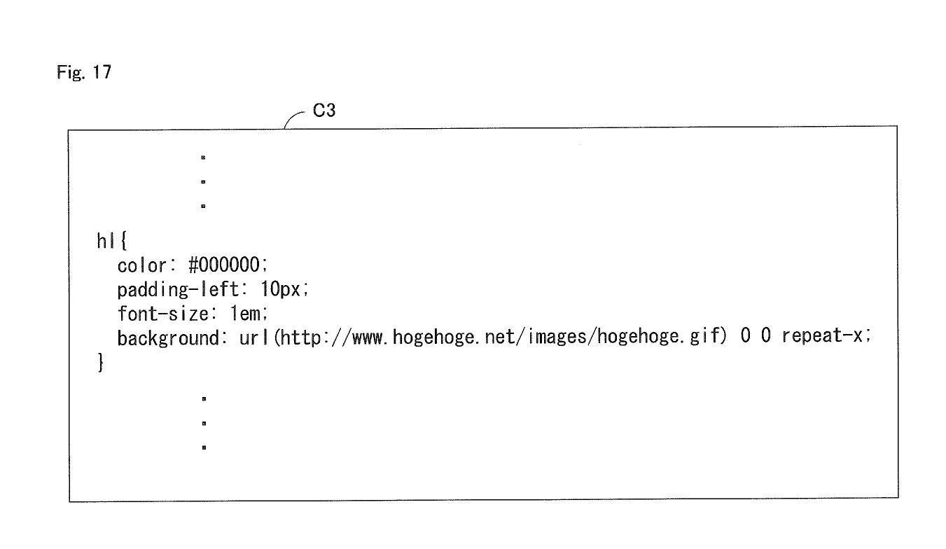

FIG. 17 shows the third example of the determination.

In FIG. 17, an example of contents C3 for specified elements in a CSS file of the web page as contents information is shown. For example, contents C3 include an URI of an image designated as a background. In case that a link to the image etc. as external contents is included and the communication protocol does not use a SSL, the contents of the web page (or the area related to the description) are identified as no safe.

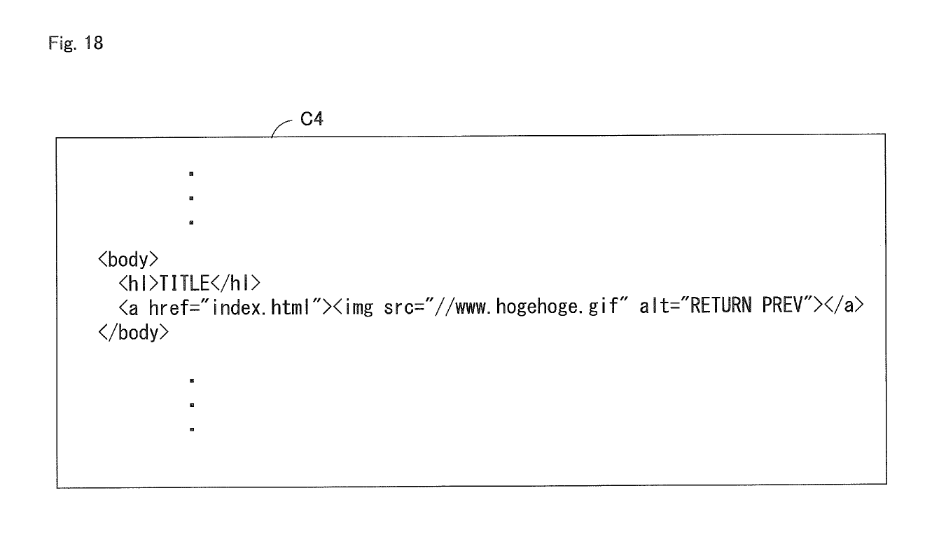

FIG. 18 shows the fourth example of the determination.

In FIG. 18, an example of body contents C4 in a HTML file of the web page as contents information is shown. In contents C4, a scheme part in the URI indicating an image to be displayed is omitted. Therefore, it is unknown whether the communication protocol is a HTTP or HTTPS etc. using a SSL. In such a case, the contents of the web page (or the area related to the description) are identified as no safe.

According to the above explanations, in the second embodiment, safeness of the web page is determined as is the case with the first embodiment. In response to the result, the processing using cloud server 60 is performed. Hence, the second embodiment has an effect similar to the first embodiment.

In the second embodiment, safe or not is determined by executing the second safety determination process, based on contents information for the web page. For the web page which may include contents being actually no safe, a partial imaging is performed by using cloud server 60. After that, MFP 101 can perform imaging of the web page. Hence, MFP 101 can improve performance of security.

### The Third Embodiment

The basic structure and basic behavior of an image forming system in the third embodiment is as same as the first embodiment. The explanation will not be repeated. In the third embodiment, a part of behavior performed by MFP 101 for a function of utilizing web pages is different from the first embodiment.

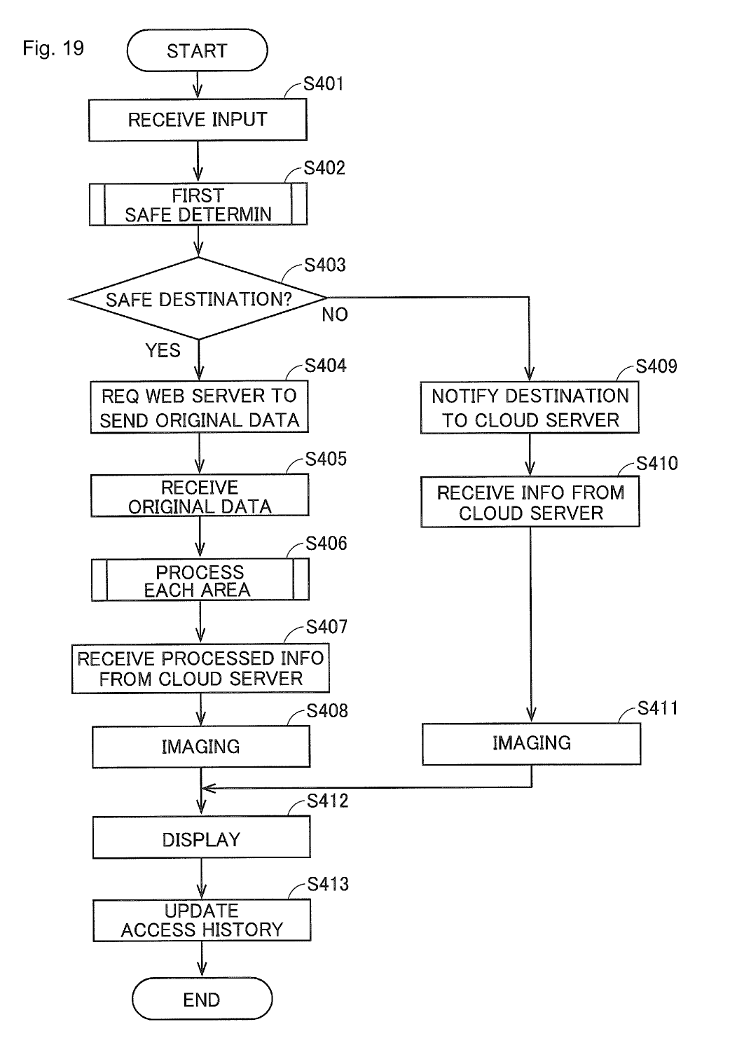

FIG. 19 shows a flowchart of behavior of the MFP 101 for a function of utilizing web pages in the third embodiment.

In FIG. 19, the processes of steps S401 to S405 are performed similarly as steps S101 to S105 of FIG. 7. The processes of steps S409 to S413 are performed similarly as steps S107 to S111 in FIG. 7.

More specifically, in this embodiment, in case that a web page is identified as safe based on the result of the first safety determination process, the process for each area is performed for the web page.

More specifically, when control unit 105 of MFP 101 receives contents information transmitted from web server 70 (step S405), the process of step S406 is executed. More specifically, the process for each area is performed at step S406.

In the third embodiment, the process for each area is performed similarly as the process for each area performed by cloud server 60 when the web page was determined as no safe in the first safety determination process. However, a part of the process for each area of the third embodiment differs from a part of the process for each area of the first safety determination process. More specifically, in the process for each area performed by MFP 101, the determination process for each area is performed based on the contents information of the web page. An imaging process for an area which was determined as no safe is not performed by MFP 101. The imaging process for an area which was determined as no safe is performed by cloud server 60. The result of the imaging process performed by cloud server 60 is transmitted from cloud server 60 to MFP 101.

At step S407, control unit 105 receives processed information transmitted from cloud server 60. More specifically, control unit 105 acquires the image of the area in which imaging was performed.

At step S408, control unit 105 executes imaging processes of the web page based on the received information processed. At this time, control unit 105 executes imaging based on the contents information, so that the images in areas after imaging of cloud server 60 are properly arranged in the web page.

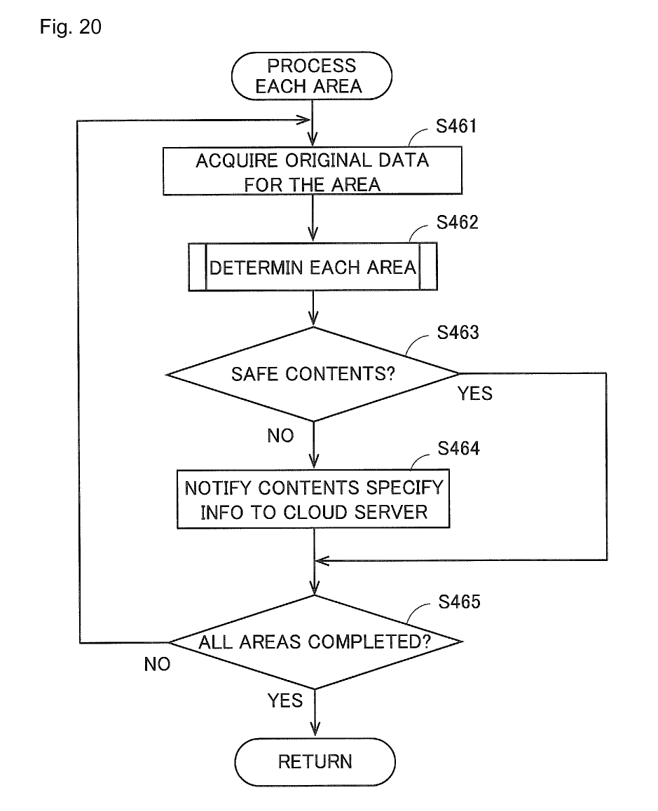

FIG. 20 shows a flowchart of determination for each of areas by the MFP 101 according to the third embodiment.

In FIG. 20, the processes of steps S461 to S463 are performed similarly as steps S161 to S163 of FIG. 11. The process of step S465 is performed similarly as step S165 in FIG. 11.

In the third embodiment, the determination process for each area is performed (S461 and S462). As for the area which was not determined as safe contents (S463: NO), the information is transmitted to cloud server 60.

More specifically, as seen from FIG. 20, at step S464, contents specifying information for the area which was determined as no safe is transmitted to cloud server 60. At this time, the contents information of the area may be transmitted. For example, information which can specify the area by a DOM (Document Object Model) or the like can be transmitted.

The contents specifying information is transmitted to cloud server 60 for each area as needed basis. Then, cloud server 60 executes behavior as follows. More specifically, cloud server 60 can perform 2 type behaviors as the behavior for each area in the following and the behavior in which the process for each area is executed for the entire web page (the behavior of FIG. 10).

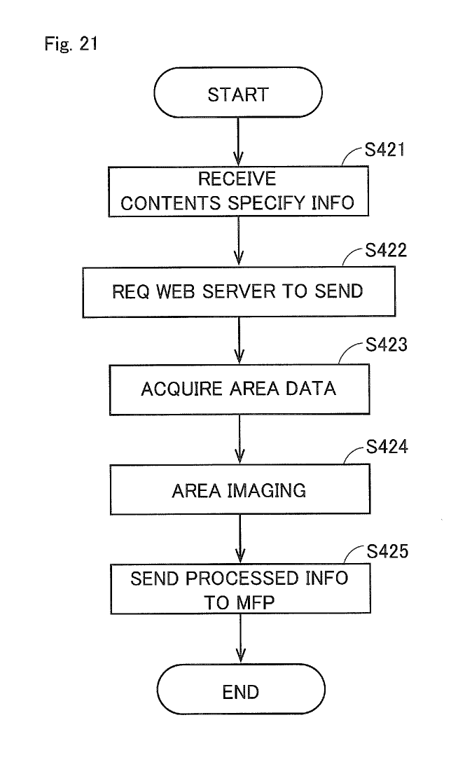

FIG. 21 shows a flowchart of an example of behavior of the cloud server 60 according to the third embodiment.

In FIG. 21, it is assumed that information which can specify the area as contents specifying information of an area which was determined as no safe is transmitted from MFP 101. Cloud server 60 performs imaging processes for the area, and transmits the result of the imaging processes as the processed information to MFP 101.

More specifically, at step S421, control unit 63 receives the contents specifying information transmitted from MFP 101.

At step S422, control unit 63 requests the web server 70 to transmit the contents information based on the contents specifying information.

At step S423, control unit 63 acquires the area information (area data) specified by the contents specifying information, from among the contents information of the web page.

At step S424, control unit 63 executes imaging (area imaging processes) for the area, based on the area data.

At step S425, control unit 63 transmits the result of the area imaging processes as the processed information to MFP 101.

When MFP 101 transmits the contents information of an area in which the imaging processes should be executed as the contents specifying information, the processes of step S423 and the following steps should be executed.

According to the above explanations, in the third embodiment, safeness of the web page is determined as is the case with the first embodiment. In response to the result, processes using cloud server 60 are performed. Hence, the third embodiment has an effect similar to the first embodiment.

In the third embodiment, in case that the web page is identified as safe by the first safety determination process, the determination for each area is performed. For the web page which may include contents being actually no safe, a partial imaging is performed by using cloud server 60. After that, MFP 101 can perform imaging of the web page. Hence, MFP 101 can improve performance of security. At this time, the information is transmitted to cloud server 60, only for an area which MFP 101 identified as no safe. It can reduce the volume of communication between cloud server 60 and MFP 101, and an overload of cloud server 60.

[Others]

A structure in which the characterizing portions in each embodiment above are partially combined may be utilized, in the absence of discrepancy. More specifically, the MFP determines safeness of the web page, and the predetermined processes are performed at the cloud server based on the result of the determination. The MFP performs the conclusive imaging processes.

For example, the MFP may not perform the first safety determination process. The MFP may determine safeness of the web page based on the contents information of the web page. More specifically, the MFP may perform only the second safety determination process shown in the second embodiment, or the determination process for each area shown in the third embodiment.

The domain information which is referred for determination of safe or not in determination information is not limited to a domain. For example, determination may be performed based on schemes, ports, host names, or the like.

The image forming system is not limited to a system using cloud servers or the like. The image forming system may perform communication between a server and a device in a client server system having a relatively simple structure. The server apparatus which communicates with the MFP may be placed at an intranet side.

The hardware configurations of devices which form the image forming system are not limited to the above. For example, each device may be an MFP, a computer, or a computerized device for mainly other uses.

Devices which form the image forming system may be black-and-white/color copying machines, printers, facsimile devices, multifunction machines (MFPs), or the like. The devices are not limited to the devices which form images by electrophotographic technology. For example, the devices may form images by so-called ink jet method.

The processes described in the above embodiments can be executed by software or a hardware circuit.

According to the embodiments, the image forming apparatus transmits information related to the web page to the external server, in response to the determination result based on the information related to the web page. The image forming apparatus performs imaging of the web page based on information transmitted from the server apparatus. Hence, an image forming apparatus, a server apparatus, an image forming system, a control method of an image forming apparatus, a control method of a server apparatus, a control program of an image forming apparatus, and a control program of a server apparatus, having high-security performance and high-processing performance for various sorts of functions can be provided.

A computer program which executes the processes in the above embodiments can be provided. The program may be provided recorded in recording media of CD-ROMs, flexible disks, hard disks, ROMs, RAM, memory cards, or the like to users. The program is executed by a computer of a CPU or the like. The program may be downloaded to a device via communication lines like the internet. The processes explained in the above flowcharts and the description are executed by a CPU in line with the program.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming apparatus comprising a processor which performs imaging of a web page provided by an external web server and provides a user with the web page, the processor is configured to:
acquire contents information of the web page which is information related to the web page;
determine whether a predetermined discrimination condition is satisfied or not for each area of the web page, based on the acquired contents information;
transmit the information related to the web page to an external server apparatus which differs from the web server, in response to the determination result;
acquire information sent from the server apparatus after the transmitting; and
execute imaging of the web page based on the acquired information which was sent from the server apparatus.

2. The image forming apparatus according to claim 1, wherein
the information related to the web page is transmitted to the server apparatus in case that the predetermined discrimination condition is not satisfied, and the information related to the web page is not transmitted to the server apparatus in case that the predetermined discrimination condition is satisfied, wherein the processor is configured to:
acquire information for imaging of the web page from the web server, in case that the predetermined discrimination condition is satisfied.

3. The image forming apparatus according to claim 1, wherein
the predetermined discrimination condition includes a condition related to a communications protocol for acquiring the contents in the web page.

4. The image forming apparatus according to claim 1, wherein the processor is configured to:
analyze structure of areas of the web page based on the contents information, and perform the determination for each area of the web page.

5. The image forming apparatus according to claim 4, wherein
the predetermined discrimination condition includes a condition related to an attribute of contents in the area of the web page.

6. The image forming apparatus according to claim 1, wherein
the predetermined discrimination condition includes a condition related to a URI (Uniform Resource Identifier) of contents in the web page.

7. The image forming apparatus according to claim 1, wherein the processor is configured to:
receive an operation for specifying a URI (Uniform Resource Identifier) related to the web page from the user;
acquire the received URI; and
determine whether a predetermined discrimination condition is satisfied or not for each area of the web page, based on the URI.

8. The image forming apparatus according to claim 6, wherein the processor is configured to:
manage an access history of the web page; wherein
the predetermined discrimination condition includes a condition in which the web page should have been accessed, or a domain to which the web page belongs should have been accessed.

9. The image forming apparatus according to claim 6, wherein
the predetermined discrimination condition includes a condition in which the web page or a domain to which the web page belongs should match a predetermined white list, or a condition in which the web page or the domain to which the web page belongs should not match a predetermined black list.

10. A server apparatus comprising a processor which can communicate with an image forming apparatus that performs imaging of a web page provided by an external web server and provides a user with the web page, wherein the processor is configured to:
receive information related to the web page, transmitted from the image forming apparatus;
acquire contents information of the web page based on the received information;
perform partially imaging of the web page based on the acquired contents information; and
send processed information to the image forming apparatus.

11. The server apparatus according to claim 10, wherein the processor is configured to:
determine whether a predetermined discrimination condition is satisfied or not, based on the acquired contents information, and perform the imaging in response to the determination result.

12. The server apparatus according to claim 11, wherein
the predetermined discrimination condition includes a condition related to a communications protocol for acquiring contents in the web page.

13. The server apparatus according to claim 11, wherein the processor is configured to:
analyze area structure of the web page, based on the contents information, and perform the determination for each area of the web page.

14. The server apparatus according to claim 13, wherein
the predetermined discrimination condition includes a condition related to an attribute of contents in the area of the web page.

15. The server apparatus according to claim 11, wherein
the predetermined discrimination condition includes a condition related to a URI (Uniform Resource Identifier) of contents in the web page.

16. An image forming system comprising an image forming apparatus which perform imaging of a web page provided by an external web server, and a server apparatus which can communicate with the image forming apparatus, wherein the image forming apparatus comprising a processor which is configured to:
acquire information related to the web page;
determine whether a predetermined discrimination condition is satisfied or not, based on the acquired information;
transmit the information related to the web page to the server apparatus in response to the determination result;
acquire information sent from the server apparatus after the transmitting; and
execute imaging of the web page based on the acquired information which was sent from the server apparatus, wherein
the server apparatus comprising a processor which is configured to:
receive the information transmitted from the image forming apparatus;
acquire contents information of the web page based on the received information;
perform partially imaging of the web page based on the acquired contents information; and
send processed information to the image forming apparatus.

17. A method of controlling an image forming apparatus which performs imaging of a web page provided by an external web server and provides a user with the web page, the method comprising the steps of:
acquire contents information of the web page which is information related to the web page;
determine whether a predetermined discrimination condition is satisfied or not for each area of the web page, based on the acquired contents information;
transmit the information related to the web page to an external server apparatus which differs from the web server, in response to the determination result;
acquire information sent from the server apparatus after the transmitting; and
execute imaging of the web page based on the acquired information which was sent from the server apparatus.

18. A method of controlling a server apparatus which can communicate with an image forming apparatus that performs imaging of a web page provided by an external web server and provides a user with the web page, the method comprising the steps of:
receive information related to the web page, transmitted from the image forming apparatus;
acquire contents information of the web page based on the received information;
perform partially imaging of the web page based on the acquired contents information; and
send processed information to the image forming apparatus.

19. A non-transitory computer-readable recording medium storing a controlling program for an image forming apparatus which performs imaging of a web page provided by an external web server and provides a user with the web page, the program causing a computer to execute the method of claim 17.

20. A non-transitory computer-readable recording medium storing a controlling program for controlling a server apparatus which can communicate with an image forming apparatus that performs imaging of a web page provided by an external web server and provides a user with the web page, the program causing a computer to execute the method of claim 18.
